(19) United States
(12) Patent Application Publication
(10) Pub. No.: US 2006/0184865 A1
(43) Pub. Date: Aug. 17, 2006

(54) Method and system for managing an electronic document

(76) Inventor: Pallab Bimalendunth Chakraborty, Fremont, CA (US)

Correspondence Address: WAGNER, MURABITO & HAO, LLP, TWO NORTH MARKET STREET, THIRD FLOOR, SAN JOSE, CA, 95113, US

(21) Appl. No.: 11/055,965

(22) Filed: Feb. 11, 2005

(51) Int. Cl. G06F 17/00; G06F 9/00; G06F 15/00

(52) U.S. Cl. 715/500; 715/751; 715/752; 715/733; 715/971

(57) ABSTRACT

A method and system for managing an electronic document. User input defining an electronic document is received. The electronic document includes a plurality of items requiring input from a plurality of reviewers of the electronic document. A workflow is automatically generated a based on the electronic document, wherein the workflow is for directing the collection of the plurality of items from the plurality of reviewers. The present invention provides an integrated solution for electronic document configuration, workflow generation and data collection.

### FIELD OF INVENTION

The present invention relates to the field of online document management. Specifically, the present invention relates to a method and system for managing an electronic document.

### BACKGROUND OF THE INVENTION

Contracts and other legal agreements often require information and/or signature acceptance from several different parties. For example, in the case of a service agreement, party A enters into a contract with party B to provide certain services to party B in exchange for monetary reimbursement. The parties negotiate the various terms and conditions of the contract, and representatives of the parties sign the service agreement.

Until the recent proliferation of computer networks, contracts and other legal agreements were paper documents that were physically signed by the contracting parties. Online acceptance of legal terms and conditions has been a standard practice from the beginning of electronic commerce for quickly putting agreements in place especially between customers or end users and the company hosting the web site. However, there does not currently exist an easy means to ensure that each of these web-based applications follow guidelines to make the legal terms and conditions enforceable in courts.

Currently, there are thousands of customized online documents and web sites that provide online acceptance. However, the online document creation is separate and not integrated with the online acceptance. Moreover, data collection associated with the online acceptance is difficult to control. For example, there are no integrated solutions for notifying a party of an online document that require the party's acceptance. In particular, because there are no integrated solutions, it is often very difficult and time consuming to generate an online document, collect data associated with that document related to online acceptance, and managing the online document against the collected data.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an exemplary computer system platform upon which embodiments of the present invention may be practiced.

FIG. 2 is a block diagram of one embodiment of a computer system network upon which the present invention may be practiced.

FIG. 3 illustrates a system for managing an electronic document, in accordance with an embodiment of the present invention

FIG. 4 illustrates an exemplary screenshot presented to the user allowing the user to generate a new electronic document, in accordance with an embodiment of the present invention.

FIG. 5 illustrates an exemplary screenshot of the roles associated with an electronic document, in accordance with an embodiment of the present invention.

FIG. 6 illustrates an exemplary screenshot of custom role page for an exemplary role, in accordance with an embodiment of the present invention.

FIG. 7 illustrates an exemplary screenshot of a document administration page, in accordance with an embodiment of the present invention.

FIG. 8 is a flowchart diagram illustrating steps of a process for managing an electronic document, in accordance with one embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and the scope of the invention as defined by the appended claims. Furthermore, in the following detailed description of the present invention, numerous specific details are set forth in order to provide a thorough understanding of the present invention. However, it will be apparent to one skilled in the art that the present invention may be practiced without these specific details. In other instances, well-known methods, procedures, components, structures and devices have not been described in detail so as to avoid unnecessarily obscuring aspects of the present invention.

Various embodiments of the present invention, a method and system for managing an electronic document, are described herein. Embodiments of the present invention provide for receiving user input defining an electronic document. The electronic document includes a plurality of items requiring input from a plurality of reviewers of the electronic document. A workflow is automatically generated a based on the electronic document, wherein the workflow is for directing the collection of the plurality of items from the plurality of reviewers. In one embodiment, a request for at least one item of the plurality of items is transmitted to at least one reviewer of the plurality of reviewers. Data associated with the item from the reviewer may then be received. In one embodiment, the workflow is automatically updated based on the data. The described invention provides for automating the task of setting up applications requiring active acceptance by one or more parties.

### Notation and Nomenclature

Some portions of the detailed descriptions which follow are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here and generally conceived to be a self-consistent sequence of steps of instructions leading to a desired result. The steps are those requiring physical manipulations of data representing physical quantities to achieve tangible and useful results. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving”, “generating”, “transmitting”, “updating”, “terminating”, “storing”, or the like, refer to the actions and processes of a computer system or similar electronic computing device. The computer system or similar electronic device manipulates and transforms data represented as electronic quantities within the computer system's registers and memories into other data similarly represented as physical quantities within the computer system memories into other data similarly represented as physical quantities within the computer system memories or registers or other such information storage, transmission, or display devices.

### Exemplary Hardware Upon Which Embodiments of the Present Invention may be Implemented

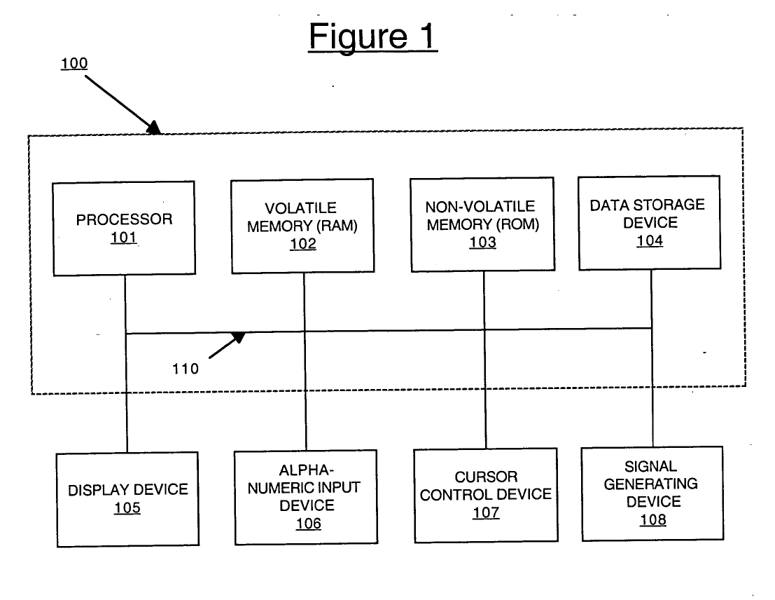

Refer now to FIG. 1 which illustrates an exemplary computer system 100 upon which embodiments of the present invention may be practiced. In general, computer system 100 comprises bus 110 for communicating information, processor 101 coupled with bus 110 for processing information and instructions, random access (volatile) memory (RAM) 102 coupled with bus 110 for storing information and instructions for processor 101, read-only (non-volatile) memory (ROM) 103 coupled with bus 110 for storing static information and instructions for processor 101, data storage device 104 such as a magnetic or optical disk and disk drive coupled with bus 110 for storing information and instructions.

In one embodiment, computer system 100 comprises an optional user output device such as display device 105 coupled to bus 110 for displaying information to the computer user, an optional user input device such as alphanumeric input device 106 including alphanumeric and function keys coupled to bus 110 for communicating information and command selections to processor 101, and an optional user input device such as cursor control device 107 coupled to bus 110 for communicating user input information and command selections to processor 101. Furthermore, an optional input/output (I/O) device 108 is used to couple computer system 100 onto, for example, a network.

Display device 105 utilized with computer system 100 may be a liquid crystal device, cathode ray tube, or other display device suitable for creating graphic images and alphanumeric characters recognizable to the user. Cursor control device 107 allows the computer user to dynamically signal the two-dimensional movement of a visible symbol (pointer) on a display screen of display device 105. Many implementations of the cursor control device are known in the art including a trackball, mouse, joystick or special keys on alphanumeric input device 106 capable of signaling movement of a given direction or manner of displacement. It is to be appreciated that the cursor control 107 also may be directed and/or activated via input from the keyboard using special keys and key sequence commands. Alternatively, the cursor may be directed and/or activated via input from a number of specially adapted cursor directing devices.

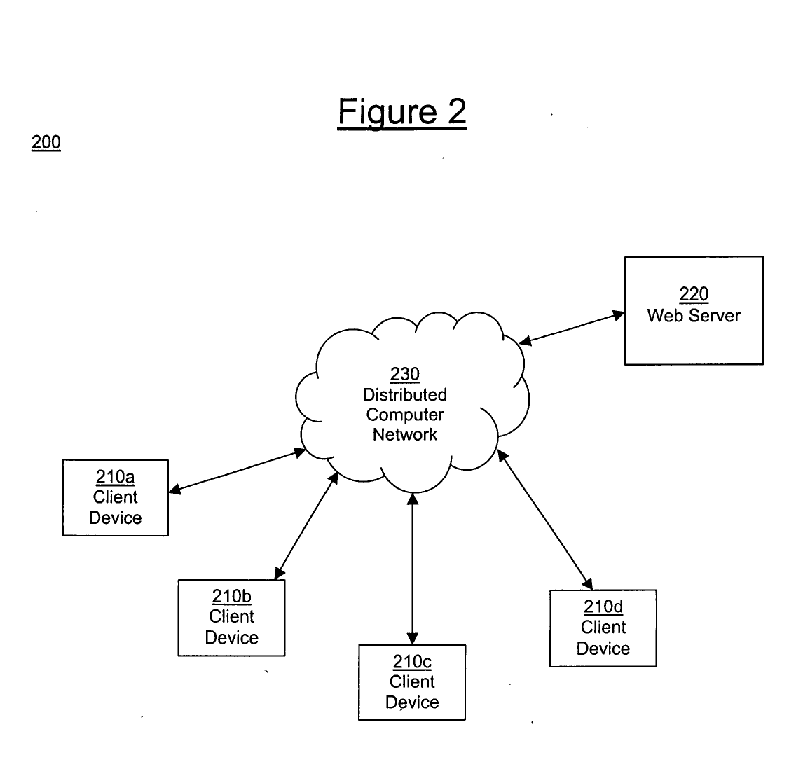

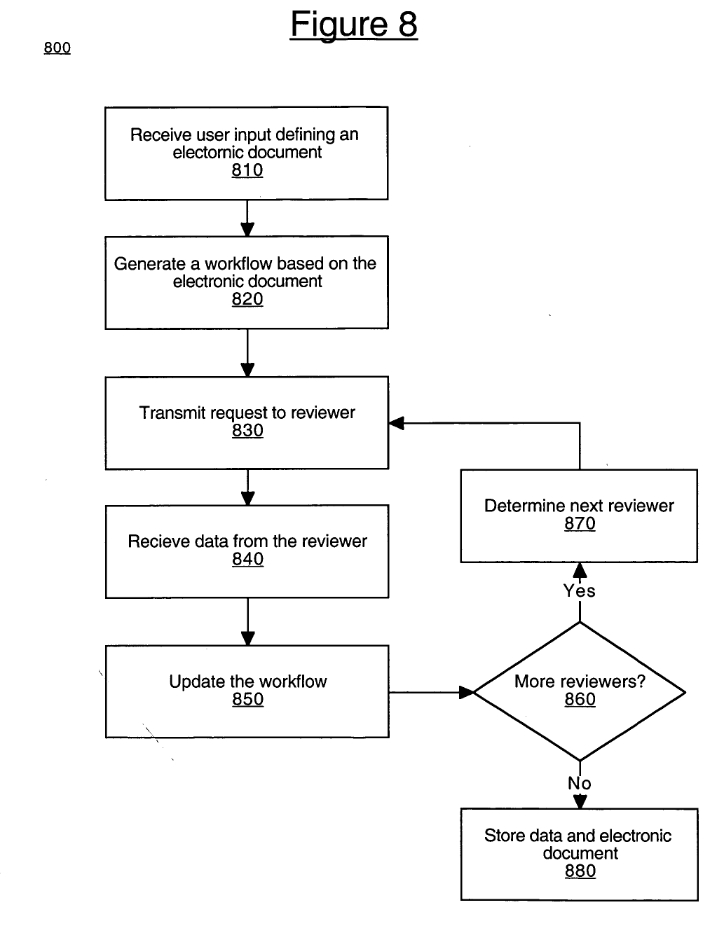

Referring now to FIG. 2, a block diagram of a computer system network 200 upon which the present invention may be practiced is shown. As depicted in FIG. 2, system 200 comprises a plurality of client devices 210a-d communicatively coupled to web server 220 via a distributed computer network 230. In one embodiment, client devices 210a-d communicate with web server 220 to access web applications (e.g., web sites) stored on web server 220. In one embodiment, web server 220 performs a method for managing contents of an electronic document (e.g., process 800 of FIG. 8). Client devices 210a-d communicate with web server 220 via the communications protocols of distributed computer network 230, hereafter referred to as network 230. It should be appreciated that client device 210a-d can comprise any number or combination of electronic devices, including but not limited to: desktop computer systems, laptop computer systems, handheld computer systems, or any electronic device capable of accessing and displaying web sites.

Referring still to FIG. 2, network 230 includes well know network technologies. For example, network 230 can be implemented using LAN technologies (e.g., Ethernet, Tokenring, etc.), the Internet, or other wired or wireless network technologies. The communications links between web server 220, client devices 210a-d and network 230 can be implemented using, for example, a telephone circuit, communications cable, optical cable, wireless link, or the like.

### A Method and System for Managing an Electronic Document

Various embodiments of the present invention, a method and system for managing an electronic document, are described. In one embodiment, the present invention provides a method for managing an electronic document wherein user input defining an electronic document is received. The electronic document includes a plurality of items requiring input from a plurality of reviewers of the electronic document. A workflow is automatically generated a based on the electronic document, wherein the workflow is for directing the collection of the plurality of items from the plurality of reviewers. In one embodiment, the method for managing the electronic document is implemented on a computer-usable medium having computer-readable program code embodied therein for causing a computer system to perform the method.

In one embodiment, the user input includes a listing of the plurality of reviewers, information defining a relationship between at least one reviewer of the plurality of reviewers and at least one portion of the document, information defining the plurality of items, and information defining a relationship between at least one item of the plurality of items and at least one portion of the document. In one embodiment, the listing of the plurality reviewers includes an email address for each reviewer of the plurality of reviewers.

In one embodiment, an item of the plurality of items includes an electronic signature of at least one reviewer of the plurality of reviewers and associated with at least a portion of the document. In another embodiment, an item of the plurality of items comprises a data field for completion by at least one reviewer of the plurality of reviewers.

In one embodiment, the method also includes transmitting a request for at least one item of the plurality of items to at least one reviewer of the plurality of reviewers. In one embodiment, the request is an electronic mail message. Data associated with the item from the reviewer may then be received. In one embodiment, the workflow is automatically updated based on the data. In one embodiment, a second request for at least a second item of the plurality of items is transmitted to at least a second reviewer of the plurality of reviewers. Second data associated with the second item may be received from the second reviewer. In one embodiment, the workflow is automatically updated based on the second data. In one embodiment, in response receiving the plurality of items from the plurality of reviewers, the workflow is terminated. The electronic document and the data associated with the plurality of items may then be stored.

In another embodiment, the present invention provides an electronic document manager including an electronic document generator, a workflow generator and a data collector. The electronic document generator is operable to receive user input defining the electronic document, wherein the electronic document includes a plurality of items requiring input from a plurality of reviewers of the electronic document. The workflow generator is operable to automatically generate a workflow based on the electronic document, the workflow for directing the collection of the plurality of items from the plurality of reviewers. The data collector is operable to receive data associated with at least one item of the plurality of items, such that the workflow generator automatically updates the workflow based on the item.

In one embodiment, the workflow generator is operable to transmit a request for at least one item of the plurality of items to at least one reviewer of the plurality of reviewers. In one embodiment, the request is an electronic mail message. In one embodiment, the workflow generator is operable to terminate the workflow in response receiving the plurality of items from the plurality of reviewers. In one embodiment, the data collector is operable to store the electronic document and the data associated with the plurality of items.

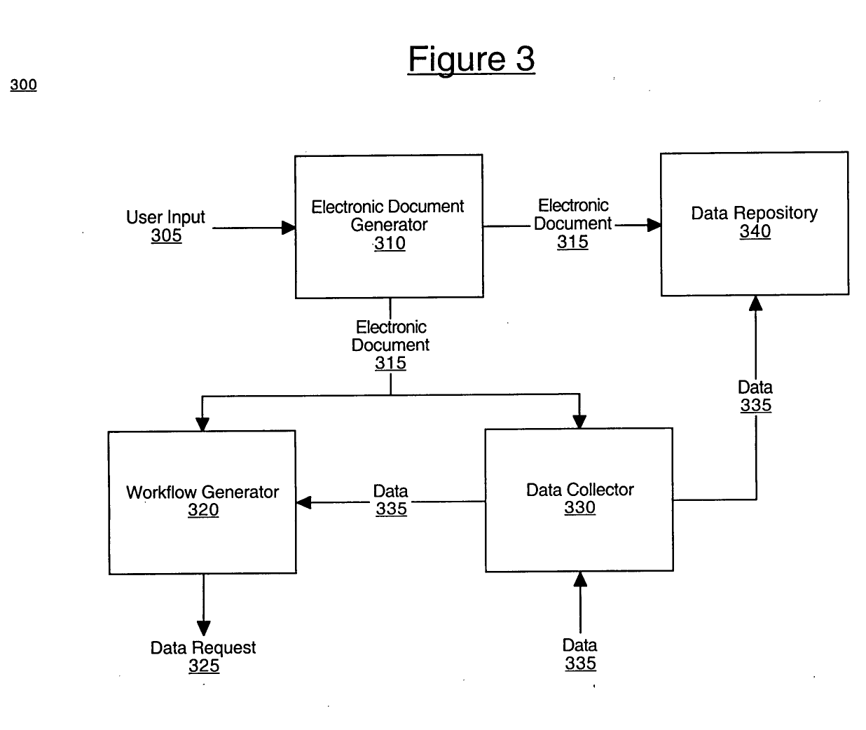

FIG. 3 illustrates a system 300 for managing an electronic document (also referred to herein as electronic document manager 300), in accordance with an embodiment of the present invention. System 300 includes electronic document generator 310, workflow generator 320, data collector 330, and data repository 340. It should be appreciated that the components of system 300 may integrated into a single computing device (e.g., web server 220 of FIG. 2), or may be distributed in part or in total among different computing devices over a computer network (e.g., distributed computer network 230 of FIG. 2). For example, electronic document generator 310, workflow generator 320 and data collector 330 may be located on one computer system, and data repository 340 may be located on a different computer system (e.g., a computer system operating a database application for receiving and storing data).

In one embodiment, system 300 may be integrated with other systems to provide an enterprise solution, such as an Enterprise Resource Planning (ERP) system. System 300 is operable to interact with multiple other systems either via Web Service APIs, Database APIs or Web Server URL redirects. The actual workflow can be triggered either by an electronic document administrator using the web-based tool, or by another system using any of the above APIs. System 300 can then keep many other systems posted with the details (e.g. the data input by the reviewers) or the status of the request (e.g. actions of the reviewers) using the above APIs. This enhances the ability of system 300 to work as integrated solutions for complex business processes requiring acceptance or electronic documents or collection of electronic data or workflows involving multiple parties (or any combination of the three processes). In one embodiment, system 300 can retrieve both data for presenting to users, as well as details of approvers by dynamically linking to other systems in real time using Web Services APIs. Thus, system 300 is able to delegate authentication to other systems and letting other systems act as data repositories alleviating the electronic document administrator from inputting all the data presented to users during the setup process.

Electronic document generator 310 is operable to receive user input 305 for defining an electronic document 315. In one embodiment, electronic document 315 is a web application (e.g., a web site) that is accessible over the Internet or another distributed computer network. Electronic document 315 includes items requiring input from a plurality of reviewers of electronic document 315, as defined by user input 305.

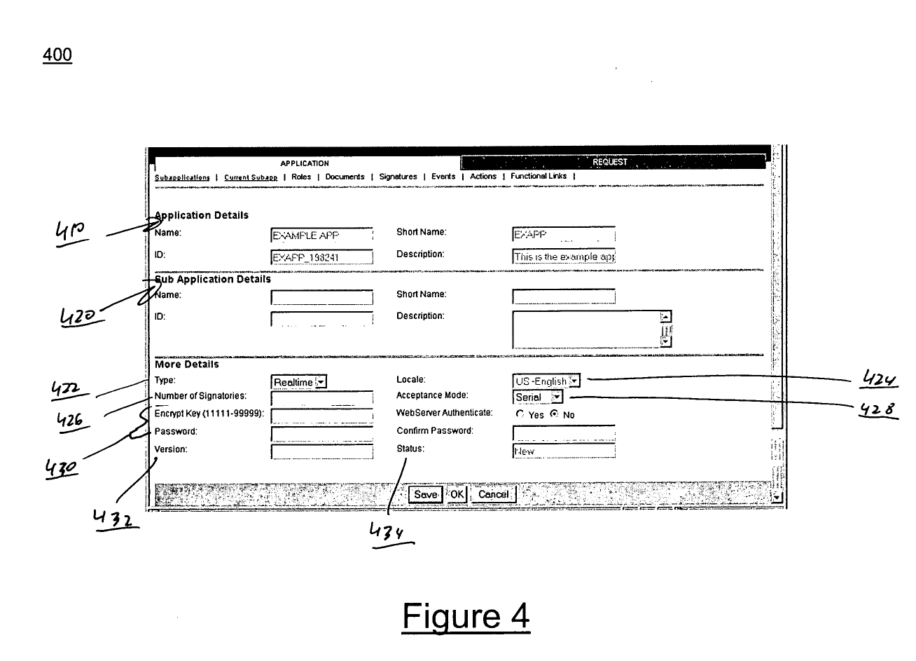

In one embodiment, a user accesses electronic document generator 310. The user (also referred to herein as the electronic document administrator) defines and customized electronic document 315 according to particular needs. FIG. 4 illustrates an exemplary screenshot 400 presented to the user allowing the user to generate a new electronic document, in accordance with an embodiment of the present invention. As shown in screenshot 400, the electronic document is referred to as either an application (Application Details 410) or a sub-application (Sub-Application Details 420). In one embodiment, the application is a point of control used by an overall system administrator, and the sub-application is the electronic document created by the electronic document administrator.

In one embodiment, the electronic document administrator is granted access to a sub-application by the overall system administrator in order to generate an electronic document. The sub-application is used to define the roles, documents, signature blocks, events and various other options and control features that are required during request generation. Throughout the definition of a sub-application, fields are defined and options are selected. Some fields are used internally in the sub-application for reference purposes. An example would be the sub-application description. Conversely some fields are defined to be external or request fields that are actually viewed by the signatories. An example of an external field would be a signature block field label (e.g., Last Name:).

The information fields for Application Details 410 and Sub-Application Details 420 include the name, the short name, the ID, and the description, which are defined as:
Name—The internal name entered when the application or sub-application was created.
Short Name—The internal short name entered when the application or sub-application was created. This field may be used as the prefix to the ID.
ID—The internally generated unique ID for the application or sub-application.
Description—An internal description entered when the application or sub-application was created.

The following are exemplary options available to define the electronic document of the sub-application: Type 422, Locale 424, Number of Signatories/Reviewers 426, Acceptance Mode 428, Security Information 430, Version 432 and Status 434, which are defined as:
Type 422—The type defines the overall nature of the sub-application as: Realtime—clients redirect to a request generated from the sub-application via an active web page; Batch—clients click on a URL generally passed through email to view the request; and Both—the sub-application can take on characteristics of both Realtime and Batch.
Locale 424—The user can choose from the available locales (e.g., US-English, French, etc.)
Number of Signatories/Reviewers 426—The number of signatories and/or reviewers of the electronic document.
Acceptance Mode 428—The acceptance mode defines the order that is used to inform signatories of a request: Serial—In serial acceptance mode the first signatory initially receives a request, after the first signatory takes an action (Accept, Decline etc;) the second signatory receives the request and so on until the last signatory has received the request and taken an action; Parallel—In parallel mode the request is sent to all signatories at once.
Security Information 430—Allows the user to define various levels of password protection and electronic document encryption.
Version 432—The internally generated version to the electronic document to identify different versions.
Status 434—An indication of the state of the sub-application (e.g., New, Draft, Active and Deleted).

Electronic document generator 310 of FIG. 3 also allows for the user to define roles of the electronic document. The roles defined by the user identify the data required by a reviewer or signatory of the electronic document. In one embodiment, a role is related to a particular portion of the electronic document. In one embodiment, the role may define which portion of the document a signatory must authorize. In another embodiment, the role may define information that a reviewer must provide (e.g., full legal name, home address, social security number, etc.)

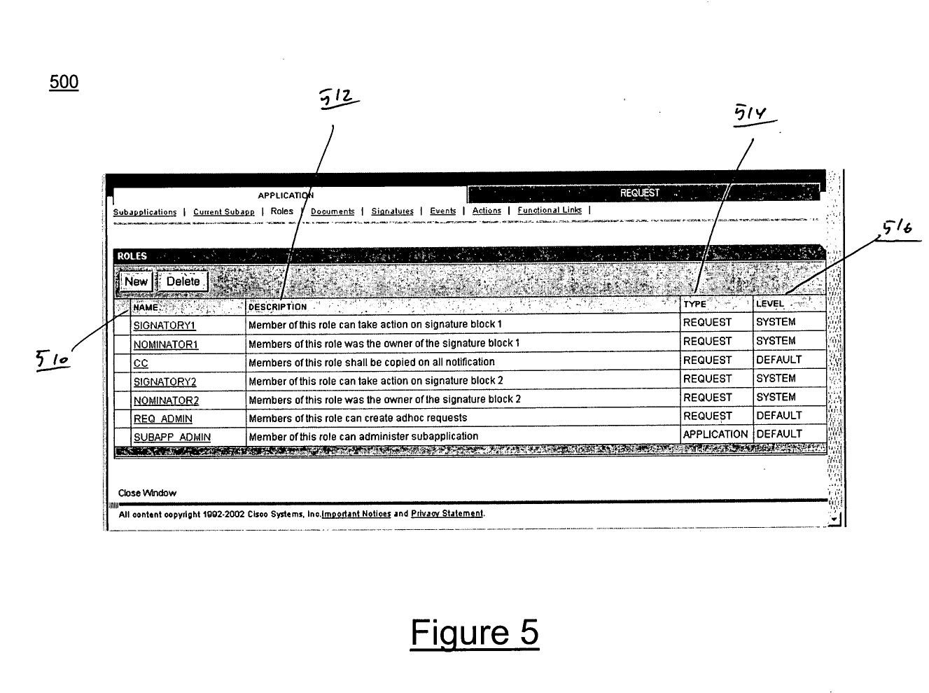

FIG. 5 illustrates an exemplary screenshot 500 of the roles associated with an electronic document, in accordance with an embodiment of the present invention. The user enters a name 510 and description 512 for each role. The name 512 is an internal role name and description 512 is an optional internal description of the role. Type 514 identifies how the electronic document is accessible by the particular role. For example, the REQUEST type role allows for access to the electronic document in response to a request for information, and the APPLICATION type role allows access to the sub-application for administering the electronic document. Level 516 may be used to associate a particular role with a particular level.

Once the roles are defined, members may be associated with role. Members are referred to herein as reviewers and signatories. A reviewer is a member that reviews the electronic document, and may be requested to provide certain information on the electronic document. A signatory is a subset of reviewers that are required to authorize the portion of the document that they review.

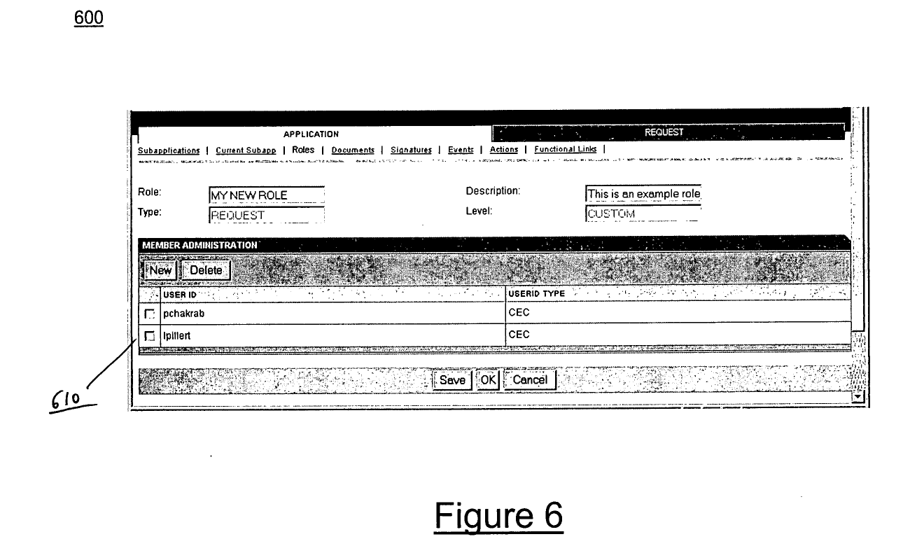

After the members have been associated with a role the custom role page will list the members. FIG. 6 illustrates an exemplary screenshot 600 of a custom role page for an exemplary role, in accordance with an embodiment of the present invention. User ID 610 identifies members of the role. In one embodiment, each member has an associated email address for transmitting requests. In one embodiment, members can then be deleted from the role by checking a UserId in the list and clicking the Delete button.

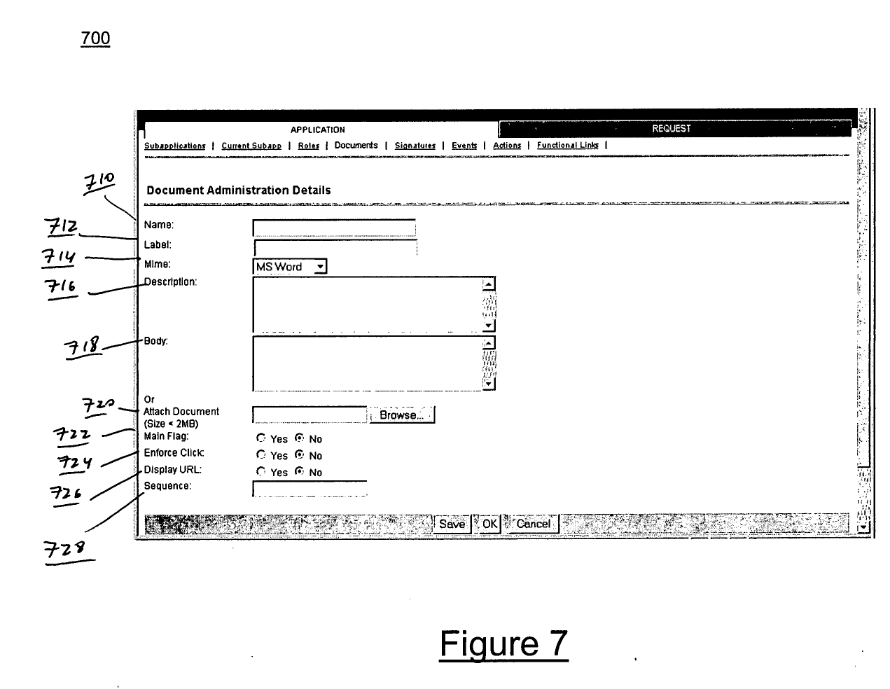

Electronic document manager 310 of FIG. 3 is also operable to receive documents associated with the electronic document. The documents are portions of the electronic document that are accessed by particular roles. FIG. 7 illustrates an exemplary screenshot 700 of a document administration page, in accordance with an embodiment of the present invention. The basic information regarding the document is entered by on this page. In addition, the actual document can be uploaded or cut and pasted into to Body field. Any number of documents can be uploaded or cut and pasted into the sub-application. The fields of screenshot 700 are described as follows:
Name 710—An internal document name provided that the administrator to identify the document.
Label 712—The label that will be presented to the signatory that describes the document. This is not displayed for the main document if the document is presented inline.
Mime 714—The MIME type of the document, MS Word, HTML etc;
Description 716—An internal description used to further identify the document.
Body 718—A list box where an HTML document can be pasted and uploaded into Click-Accept. Text documents can also be pasted here but the presentation quality on the request cannot be predicted.
Attach Document 720—Using the browse button a file can be uploaded from a local file into the Click-Accept system. The file size must be less that 2 MB and match the MIME type selected previously.
Main Flag 722—Selecting this flag as YES indicates that this document is the main document to be presented to the signatory. If the MIME type is HTML and the DISPLAY URL flag is set to NO the document will be displayed inline on the page.
Enforce Click 724—Setting this flag to YES will force the signatory to open the document (purportedly to read) prior to taking an action.
Display URL 726—This flag is only applicable to the main document. When it is set to YES, it indicates that the main document should be presented as a URL link on the page. All supporting documents are displayed as a URL link.
Sequence 728—Automatically generated sequence number that indicates the display order of the supporting documents.

In one embodiment, the electronic document administrator can define a signature for all signatories required to take action on a request. In one embodiment, the electronic document administrator can control the sequence of presentation of the request. Moreover, the electronic document administrator may assign specific settings to a signature block. For example, the signature block may be made mandatory, wherein the signature block must be acted on to complete the request. In one embodiment, if the signature block is not acted on, or is specifically declined, the reviewer cannot approve the electronic document. An approver of the electronic document may subsequently decline the request.

In another embodiment, the electronic document administrator can define information that is requested of the request recipient. In one embodiment, a data field can be defined for a reviewer to submit information. In one embodiment, the electronic document administrator may assign specific settings to a data field. For example, the data field may be made mandatory, wherein the data field must be completed on to complete the request. If the data field is not completed, the entire request is declined.

With reference to FIG. 3, workflow generator 320 is operable to automatically generate a workflow based on the electronic document 315. The workflow is for directing the collection of request information. In one embodiment, the workflow is generated based on the roles as defined by the user and the acceptance mode (e.g., acceptance mode 428 of FIG. 4). In one embodiment, workflow generator 320 is operable to transmit a request 325 to at least one reviewer. In one embodiment, request 325 is an electronic mail message. In one embodiment, the electronic mail message includes a URL for directing the reviewer to the electronic document. In one embodiment, the request is for an electronic signature of the reviewer. In another embodiment, the request is for completion of at least one data field by the reviewer.

Data collector 330 is operable to receive data 335 from the reviewer. In one embodiment, data collector 330 transmits data 335 to workflow generator 320, such that the workflow can be updated based on data 335 being received. For example, where the acceptance is defined as serial, workflow generator 320, in response to the receipt of data 335 based on a first request, can transmit a second request. In one embodiment, workflow generator 320 is operable to terminate the workflow in response receiving all requested data.

In one embodiment, data repository 340 is operable to store data 335 and electronic document 315. Upon collection of all requested information, the electronic document administrator can access electronic document 315 and data 335 by accessing data repository 340, to verify the collection of the requested data. In one embodiment, electronic document 315 can be populated with data 335 to produce a finalized electronic document.

The described embodiments provide a combination of three separate functions to deliver a unique online acceptance platform: document generation, workflow generation, and data collection. Moreover, the present invention provides the following functionality:
Add any number of supporting documents to the main document, and make them mandatory to be opened during end user acceptance.
Ability to hide one or more approvers from one another, or other users with additional restrictions based on status of the request.
Ability to hide certain supporting documents from one or more approvers, including restrictions by status.
Ability to cross-reference any number of other requests or static web pages and make them mandatory for viewing, while presenting the new request for acceptance. This can be used for contracts with multiple addendums and amendments.
Ability for end users to create case logs and upload files during acceptance.
Ability to configure any number of parties to sign the presented document(s) as well as the intermediate step of confirming their action. Thus, the action might be mandated to need confirmation from the end user or bypass the confirm page.
Ability to configure the labels of all documents, form fields, action buttons during presentation. In addition, the emails sent to users are configurable during setup, as well as the ability to tie them to action, escalation or calendar events.
Ability to configure the number of steps in the acceptance/decline processes. The optional step of confirming the action can be added for more stringent acceptances.
Ability for the signatory to nominate another person from the same organization on their behalf.
Ability to configure an arbitrary number of data fields along with workflow/approvals and original document, with the ability to include just the data fields like a survey questionnaire. The data fields can be visually grouped together or related in a parenting relationship during setup
Ability to interface with multiple sub-applications and be a single runtime engine for all of them, yet segregating the data and enforcing security. Each sub-application running on the engine can have its own delegated security/authentication mechanism depending on its unique needs
Ability to configure local languages at multiple levels: just the documents used in the transaction, documents and data fields or the entire sub-application including user messages and errors.

FIG. 8 is a flowchart diagram illustrating steps of a process 800 for managing an electronic document, in accordance with one embodiment of the present invention. In one embodiment, process 800 is carried out by processors and electrical components under the control of computer readable and computer executable instructions. Although specific steps are disclosed in process 800, such steps are exemplary. That is, the embodiments of the present invention are well suited to performing various other steps or variations of the steps recited in FIG. 8. In one embodiment, process 800 is executed by electronic document manager 300 of FIG. 3.

At step 810 of process 800, user input defining an electronic document is received (e.g., at electronic document generator 310 of FIG. 3). The electronic document includes a plurality of items requiring input from a plurality of reviewers of the electronic document. In one embodiment, the user input includes a listing of the plurality of reviewers, information defining a relationship between at least one reviewer of the plurality of reviewers and at least one portion of the document, information defining the plurality of items, and information defining a relationship between at least one item of the plurality of items and at least one portion of the document. In one embodiment, the listing of the plurality reviewers includes an email address for each reviewer of the plurality of reviewers.

In one embodiment, an item of the plurality of items includes an electronic signature of at least one reviewer of the plurality of reviewers and associated with at least a portion of the document. In another embodiment, an item of the plurality of items comprises a data field for completion by at least one reviewer of the plurality of reviewers.

At step 820, a workflow is generated a based on the electronic document (e.g., at workflow generator 320 of FIG. 3). The workflow is for directing the collection of the plurality of items from the plurality of reviewers. In one embodiment, the workflow is automatically generated based on the electronic document. In another embodiment, the workflow may be manually created. For example, the electronic document administrator may modify the workflow and add complex details like committees of approvers (with rules like number of people required to proceed or stop the workflow, and any special attributes), special handling of declines by non-mandatory approvers, etc.

At step 830, a request for at least one item of the plurality of items is transmitted to at least one reviewer of the plurality of reviewers (e.g., at workflow generator 320 of FIG. 3). In one embodiment, the request is an electronic mail message. At step 840, data associated with the item from the reviewer is received (e.g., at data collector 330 of FIG. 3). In one embodiment, as shown at step 850, the workflow is automatically updated based on the data (e.g., at workflow generator 320 of FIG. 3).

At step 860, it is determined if there are more reviewers for the electronic document. If there are more reviewers, process 800 proceeds to step 870 and determines the next reviewer. Process 800 then returns to step 830, and transmits a request to the next reviewer. Alternatively, if there are no more reviewers, process 800 proceeds to step 880. At step 880, the workflow is terminated and the data and the electronic document are stored (e.g., at data repository 340 of FIG. 3).

The described embodiments of the present invention provide a method and system for setting up web applications that can gather active feedback from users and store the responses in an integrated repository. The electronic document that needs to be presented to reviewers is generated based on user input. The present invention allows for the configuration of the electronic document, the chain of signatories and/or reviewers acting on the electronic document, and the exact content and conditions of sending the emails to people associate with the actual instance. The present invention provides an integrated solution for electronic document configuration, workflow generation and data collection.

Various embodiments of the present invention, a method and system for managing an electronic document, are thus described. While the present invention has been described in particular embodiments, it should be appreciated that the present invention should not be construed as limited by such embodiments, but rather construed according to the below claims.

What is claimed is:

1. A method for managing an electronic document, said method comprising:
receiving user input defining said electronic document, said electronic document comprising a plurality of items requiring input from a plurality of reviewers of said electronic document; and
automatically generating a workflow based on said electronic document, said workflow for directing the collection of said plurality of items from said plurality of reviewers.

2. The method as recited in claim 1 further comprising:
transmitting a request for at least one item of said plurality of items to at least one reviewer of said plurality of reviewers; and
receiving data associated with said item from said reviewer.

3. The method as recited in claim 2 wherein said request is an electronic mail message.

4. The method as recited in claim 2 further comprising automatically updating said workflow based on said data.

5. The method as recited in claim 4 further comprising:
transmitting a second request for at least a second item of said plurality of items to at least a second reviewer of said plurality of reviewers; and
receiving second data associated with said second item from said second reviewer.

6. The method as recited in claim 5 further comprising automatically updating said workflow based on said second data.

7. The method as recited in claim 1 further comprising:
in response receiving said plurality of items from said plurality of reviewers, terminating said workflow; and
storing said electronic document and said data associated with said plurality of items.

8. The method as recited in claim 1 wherein said user input comprises a listing of said plurality of reviewers, information defining a relationship between at least one reviewer of said plurality of reviewers and at least one portion of said document, information defining said plurality of items, and information defining a relationship between at least one item of said plurality of items and at least one portion of said document.

9. The method as recited in claim 8 wherein said listing of said plurality reviewers comprises an email address for each reviewer of said plurality of reviewers.

10. The method as recited in claim 1 wherein an item of said plurality of items comprises an electronic signature of at least one reviewer of said plurality of reviewers and associated with at least a portion of said document.

11. The method as recited in claim 1 wherein an item of said plurality of items comprises a data field for completion by at least one reviewer of said plurality of reviewers.

12. A computer-usable medium having computer-readable program code embodied therein for causing a computer system to perform a method for managing an electronic document, said method comprising:
receiving user input defining said electronic document, said electronic document comprising a plurality of items requiring input from a plurality of reviewers of said electronic document; and
automatically generating a workflow based on said electronic document, said workflow for directing the collection of said plurality of items from said plurality of reviewers.

13. The computer-usable medium as recited in claim 12 wherein said method further comprises:
transmitting a request for at least one item of said plurality of items to at least one reviewer of said plurality of reviewers; and
receiving data associated with said item from said reviewer.

14. The computer-usable medium as recited in claim 13 wherein said request is an electronic mail message.

15. The computer-usable medium as recited in claim 13 wherein said method further comprises automatically updating said workflow based on said data.

16. The computer-usable medium as recited in claim 15 wherein said method further comprises:
transmitting a second request for at least a second item of said plurality of items to at least a second reviewer of said plurality of reviewers; and
receiving second data associated with said second item from said second reviewer.

17. The computer-usable medium as recited in claim 15 wherein said method further comprises automatically updating said workflow based on said second data.

18. The computer-usable medium as recited in claim 12 wherein said method further comprises:
in response receiving said plurality of items from said plurality of reviewers, terminating said workflow; and
storing said electronic document and said data associated with said plurality of items.

19. The computer-usable medium as recited in claim 12 wherein said user input comprises a listing of said plurality of reviewers, information defining a relationship between at least one reviewer of said plurality of reviewers and at least one portion of said document, information defining said plurality of items, and information defining a relationship between at least one item of said plurality of items and at least one portion of said document.

20. The computer-usable medium as recited in claim 19 wherein said listing of said plurality reviewers comprises an email address for each reviewer of said plurality of reviewers.

21. The computer-usable medium as recited in claim 12 wherein an item of said plurality of items comprises an electronic signature of at least one reviewer of said plurality of reviewers and associated with at least a portion of said document.

22. The computer-usable medium as recited in claim 12 wherein an item of said plurality of items comprises a data field for completion by at least one reviewer of said plurality of reviewers.

23. An electronic document manager comprising:
an electronic document generator for receiving user input defining said electronic document, said electronic document comprising a plurality of items requiring input from a plurality of reviewers of said electronic document;
a workflow generator for automatically generating a workflow based on said electronic document, said workflow for directing the collection of said plurality of items from said plurality of reviewers; and
a data collector for receiving data associated with at least one item of said plurality of items, such that said workflow generator automatically updates said workflow based on said item.

24. The electronic document manager as recited in claim 23 wherein said workflow generator is operable to transmit a request for at least one item of said plurality of items to at least one reviewer of said plurality of reviewers.

25. The electronic document manager as recited in claim 24 wherein said request is an electronic mail message.

26. The electronic document manager as recited in claim 23 wherein said workflow generator is operable to terminate said workflow in response receiving said plurality of items from said plurality of reviewers.

27. The electronic document manager as recited in claim 23 further comprising a data repository for storing said electronic document and said data associated with said plurality of items.

29. The electronic document manager as recited in claim 23 wherein said user input comprises a listing of said plurality of reviewers, information defining a relationship between at least one reviewer of said plurality of reviewers and at least one portion of said document, information defining said plurality of items, and information defining a relationship between at least one item of said plurality of items and at least one portion of said document.

30. The electronic document manager as recited in claim 29 wherein said listing of said plurality reviewers comprises an email address for each reviewer of said plurality of reviewers.

31. The electronic document manager as recited in claim 23 wherein an item of said plurality of items comprises an electronic signature of at least one reviewer of said plurality of reviewers and associated with at least a portion of said document.

32. The electronic document manager as recited in claim 23 wherein an item of said plurality of items comprises a data field for completion by at least one reviewer of said plurality of reviewers.
